(19) United States
(12) Patent Application Publication
(10) Pub. No.: US 2026/0135455 A1
(43) Pub. Date: May 14, 2026

(54) VIBRATION MOTOR, IN PARTICULAR FOR A HOROLOGY MOVEMENT

(71) Applicant: The Swatch Group Research and Development Ltd, Marin (CH)

(72) Inventors: Lionel PARATTE, Marin-Epagnier (CH); Jean-Jacques BORN, Morges (CH); Joerg BERTHOUD, Villeret (CH)

(73) Assignee: The Swatch Group Research and Development Ltd, Marin (CH)

(21) Appl. No.: 19/348,352

(22) Filed: Oct. 2, 2025

(30) Foreign Application Priority Data
Nov. 13, 2024 (EP) 24212706.6

(51) Int. Cl. H02K 33/02; G04C 3/10; H02K 7/116

(52) U.S. Cl. CPC H02K 33/02; G04C 3/104; H02K 7/116

(57) ABSTRACT

A vibration motor (1), in particular for a horology movement, the motor (1) including a rotor (2) fitted with a magnet, a stator (3) fitted with at least one coil enabling the rotation of the rotor (2) to be actuated, the rotor (2) being rotationally mobile relative to the stator (3) by oscillation between two end positions, when it is actuated by the coil, and including resilient means for returning the rotor (2) between the end positions and an intermediate locked position, when the rotor (2) is no longer actuated by the coil, the motor (1) functioning by a rotationally oscillating movement of the rotor (2) to generate each step.

### CROSS-REFERENCE TO RELATED APPLICATIONS

This application claims priority to European Patent Application No. 24212706.6, filed on Nov. 13, 2024, the entire contents of which are incorporated herein by reference.

### TECHNICAL FIELD OF THE INVENTION

The invention relates to the field of stepping motors, particularly for horology. The invention more specifically relates to a vibration or oscillating motor.

### TECHNOLOGICAL BACKGROUND

In most electronic horology movements, the energy required to rotate the hands (for example the second, minute and hour hands) is provided by a stepping motor such as a Lavet motor.

These single-phase motors have a rotor that turns in steps and makes half a turn relative to the stator at each step, to define each second. With each step, the rotor drives the trains in the horology movement, which in turn drive the hands. Step rate is generally determined by a time base with a quartz resonator.

When the motor is running, a positioning couple holds the rotor in set positions, and a magnet-coil coupling enables the rotor to be turned between these positions. However, as the coupling is a sinusoidal function of the rotor position, a loss of efficiency is observed over part of the turn.

The rotor is also fitted in bearings so that it can turn. However, this type of assembly generates friction between the rotor pivots and the bearings. This friction is caused by the weight of the rotor, by the lateral attraction of the rotor magnet, and by the contact between the movement trains and the rotor pinion when the trains are driven by the rotor.

As a result, these problems cause energy losses and thereby increased consumption compared to what is necessary for the motor to run efficiently.

### SUMMARY OF THE INVENTION

The present invention aims to remedy all or part of the drawbacks described above by providing a motor with reduced fuel consumption compared to a Lavet motor.

To this end, the invention relates to a vibration motor, in particular for a horology movement, the motor comprising a rotor fitted with a magnet, a stator fitted with at least one coil enabling the rotation of the rotor to be actuated in steps, the rotor being rotationally mobile relative to the stator by oscillation between two angular end positions, when it is actuated by the coil.

A remarkable feature of the invention is that the motor comprises resilient means for returning the rotor between the end positions and an intermediate locked position, when the rotor is no longer actuated by the coil, the motor functioning by a rotationally oscillating movement of the rotor to generate each step.

The motor functions by a rotationally oscillating movement of the rotor between the two end positions at its resonant frequency to generate each step of the motor. In this way, the motor moves to and fro, causing the motor to make incremental gains.

Such a motor makes it possible to reduce the angular travel of the rotor compared to a single-phase Lavet motor, so that the electromagnetic coupling between the magnet and the coils is more efficient, as it is located around the maximum of the sinusoidal function of the coupling.

Moreover, the rotor is also rotationally guided by the aforementioned resilient return means instead of the bearings, such that friction between the rotor arbor and the bearings that hold it is avoided.

With the invention, energy losses are reduced, which in turn reduces the consumption of the motor, for example by half in the case of certain motors.

According to a particular embodiment of the invention, the resilient return means comprise a flexible guide arranged to suspend the rotor from the stator.

According to a particular embodiment of the invention, the flexible guide comprises an upper flexible part connecting the top of the rotor above the stator, and a lower flexible part connecting the bottom of the rotor below the stator.

According to a particular embodiment of the invention, the upper flexible part and/or the lower flexible part of the flexible guide comprises at least one pair of uncrossed flexible blades, preferably two pairs of uncrossed flexible blades arranged in parallel.

According to a particular embodiment of the invention, the upper flexible part and/or the lower flexible part of the flexible guide comprises at least one single flexible blade, preferably two single flexible blades arranged in parallel.

According to a particular embodiment of the invention, the flexible guide comprises a static element attached to the stator, and a mobile element attached to the rotor, the static element and the mobile element being connected by the flexible blades on the flexible guide.

According to a particular embodiment of the invention, the flexible guide comprises an intermediate bow arranged around the rotation arbor on the rotor, the two pairs of flexible blades connecting the intermediate bow to the mobile element by a first pair of flexible blades, and to the static element by the other pair of flexible blades.

According to a particular embodiment of the invention, the two pairs of flexible blades are symmetrically arranged on either side of the intermediate bow.

According to a particular embodiment of the invention, the flexible guide comprises a central bow arranged around the rotation arbor on the rotor, the single flexible blades connecting the central bow to the mobile element by a first single flexible blade, and to the static element by the other single flexible blade.

According to a particular embodiment of the invention, the motor comprises a meshing pinion for meshing with trains, in particular in the horology movement, the meshing pinion being pivotally fitted above the rotor.

According to a particular embodiment of the invention, the motor comprises a wheel with non-return clicks, as well as mobile clicks fitted on the rotor and fixed clicks fitted on the stator.

According to a particular embodiment of the invention, the meshing pinion and the click wheel are attached to the rotor in a first direction of rotation of the rotor, and are fitted so as to pivot freely around the rotation arbor on the rotor in a second direction of rotation of the rotor.

According to a particular embodiment of the invention, when the rotor vibrates between two end positions, the click wheel is driven by the mobile clicks to turn with the rotor relative to the stator in one direction, while the click wheel is retained by the fixed clicks, when the rotor turns in the reverse direction, at each oscillation period of the rotor.

According to a particular embodiment of the invention, the total angle of rotation between the end positions is less than half a turn, preferably less than a quarter turn or even less than an eighth of a turn, so as to oscillate around the maximum magnet-coil couple.

According to a particular embodiment of the invention, when in the locked position, the magnetisation vector of the magnet is directed substantially perpendicularly to the main axis of the magnetic flux φ created by the coil, so as to obtain a maximum magnet-coil couple.

According to a particular embodiment of the invention, the motor is configured to vibrate at its natural frequency, determined in particular by the inertia of the rotor and of said resilient return means, so as to minimise power consumption.

The invention also relates to a horology movement comprising such a vibration motor.

### BRIEF DESCRIPTION OF THE FIGURES

The purposes, advantages and characteristics of the present invention will become apparent on reading several embodiments provided solely by way of non-limiting examples, with reference to the appended drawings in which:

FIG. 1 schematically shows a partial perspective view of a vibration motor according to a first embodiment of the invention, in particular for a horology movement,

FIG. 2 schematically shows a partial top view of the vibration motor in FIG. 1,

FIG. 3 schematically shows a cross-sectional view of a vibration motor according to a second embodiment of the invention,

FIG. 4 schematically shows a top view of the vibration motor in FIG. 3,

FIG. 5a and FIG. 5b show two steps in the functioning of the click wheel,

FIG. 6 is a graphical representation of the timing of the vibration motor according to the invention, and

FIG. 7 schematically shows a magnet and a coil of the motor according to the invention, and

FIG. 8 is a graph showing the magnet-coil couple according to the angle of the rotor on the vibration motor according to the invention.

### DETAILED DESCRIPTION OF THE INVENTION

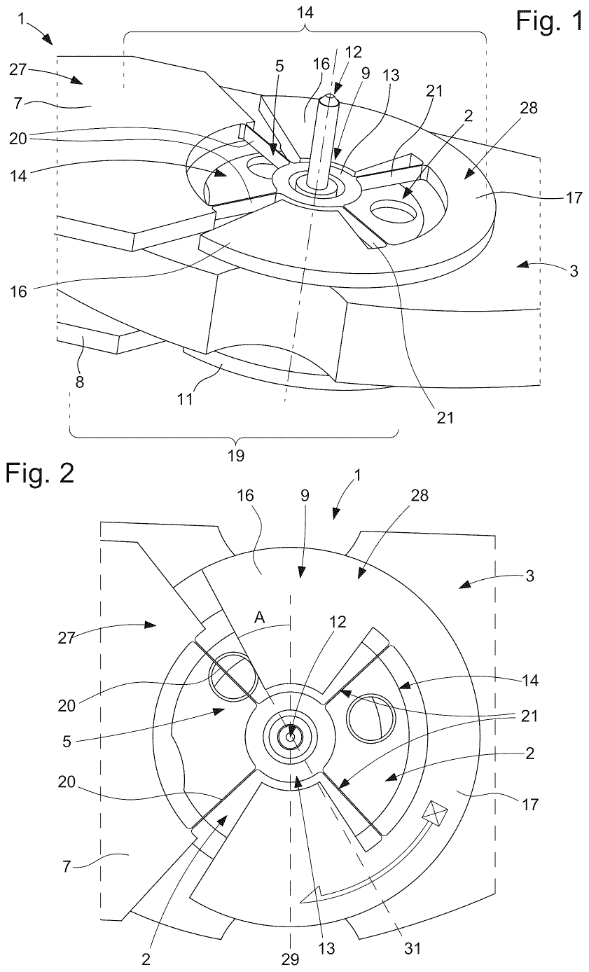

FIGS. 1 and 2 show a schematic representation of a first embodiment of a vibration motor 1 according to the invention, with a cross arrangement of flexible blades on the flexible guide. Such a motor 1 is used, for example, as an actuator in a horology movement, in particular to drive trains which in turn actuate a display device, for example with hands.

The motor 1 comprises a rotor 2 and a stator 3, the rotor 2 being fitted so as to be rotationally mobile inside a stationary stator 3. The rotor 2 is

fitted with a permanent magnet and comprises a cylindrical body, generally a plastic overmould of the magnet. The stator 3 comprises a body fitted with a circular through opening, enabling the rotor 2 to be positioned therein. The stator 3 is fitted with one or more coils to actuate the rotation of the rotor 2.

The rotor 2 comprises, on one hand, an axial arbor 12 extending above the cylindrical body, from axial discs arranged above and below the cylinder of the rotor 2.

The motor 1 also comprises a meshing pinion 15 fitted to the rotor 2. The meshing pinion 15 is rotationally attached to the rotor 2, in particular in a first direction of rotation of the rotor 2, but it can also pivot freely around the axial arbor 12 of the rotor 2 above the cylindrical body, in particularly in a second direction of rotation of the rotor 2.

Such a meshing pinion 15 can be meshed, for example, with the trains in a horology movement, not shown in the figures.

The meshing pinion 15 is rotationally mobile relative to the stator 3 in a first direction, when the rotor 2 vibrates between the two end positions, when it is actuated by the coils.

The motor 1 thus functions by a rotationally oscillating movement of the rotor 2 between the two end positions to generate each step of the motor 1.

To this end, according to the invention, the motor 1 comprises resilient means for returning the rotor 2 from the end positions to a locked position, when the rotor 2 is no longer actuated by the coils. Preferably, the locked position is arranged halfway between the end positions.

The return means comprise a flexible guide 5 arranged to suspend the rotor 2 and guide it rotationally, and to exert a force to return the rotor 2 to its locked position.

The flexible guide 5 comprises a static element 27 attached to the stator 3 and a mobile element 28 attached to the rotor 2, the static element 27 and the mobile element 28 being connected by the resilient return means.

In this case, the static element 27 comprises two plates 7, 8 fitted so as to be superimposed on the stator 3, a first plate 7 above the stator 3, and the second plate 8 arranged below the stator 3.

In a first embodiment, referred to as a cross, shown in FIGS. 1 and 2, the mobile element comprises two portions of discs 9, 11 which are partially open, one portion 9 being superimposed above the rotor 2, and the other portion 11 being arranged below the rotor 2. Each portion of a disc 9, 11 comprises two inner loops 16, connected to the rotor 2, and joined together by a bow 17 section.

The flexible guide 5 comprises an upper flexible part 14 connecting the top of the rotor 2 above the stator 3, and a lower flexible part 19 connecting the bottom of the rotor 2 below the stator 3.

Preferably, the upper flexible part 14 and the lower flexible part 19 are substantially identical.

The upper flexible part 14 and/or the lower flexible part 19 comprise at least one pair of uncrossed flexible blades 20, preferably two pairs of uncrossed flexible blades 20, 21, which are arranged above the rotor 2.

The two pairs of flexible blades 20, 21 are connected by an intermediate bow 13 arranged around the arbor 12 of the rotor 2, the two pairs of flexible blades 20, 21 being arranged symmetrically on either side of the intermediate bow 13. The first pair of flexible blades 20 connects the intermediate bow 13 to the static element, in this case the top plate 7 or the bottom plate 8, and the second pair of flexible blades 21 connects the intermediate bow 13 to the mobile element, in this case the disc portion 9.

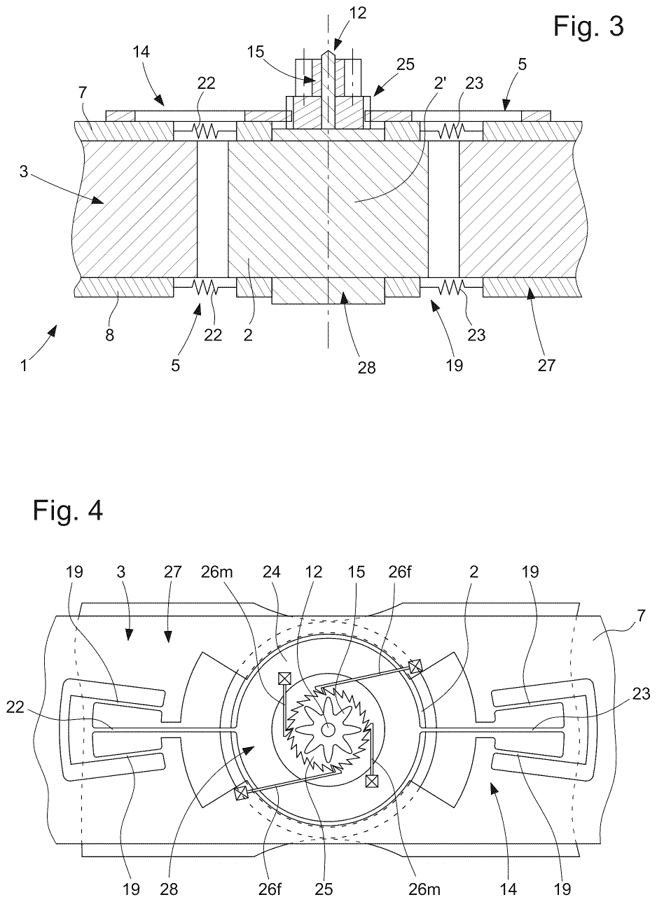

FIGS. 3 and 4 show a second embodiment of the motor 1 according to the invention, with another arrangement, referred to as in-line, of the flexible blades of the flexible guide 5. No functional difference has been made between these embodiments, as they both enable the rotor 2 to be rotationally guided.

The upper flexible part 14 and/or the lower flexible part 19 of the flexible guide 5 comprises at least two flexible blades 22, 23 arranged in parallel. The two flexible blades 22, 23 are arranged symmetrically on the rotor 2, and each connect, on one hand, a central bow 24 fitted concentrically on or under the rotor 2, and on the other hand, the upper plate 7 or the lower plate 8 of the static element 27 by two pairs of flexible blades 19.

The two flexible blades 22, 23 are substantially collinear when the rotor 2 is in the locked position.

Thus, in both embodiments, the flexible guide 5 returns the rotor 2 from the end positions to the locked position, when the rotor 2 is no longer actuated by the coil(s).

The flexible blades on the flexible guide 5 are substantially straight when the rotor 2 is in the locked position of the flexible guide 5. On the other hand, when in the actuated position, the blades on the flexible guide 5 are curved, as they are stressed by the position of the rotor 2 relative to the stator 3.

Preferably, an angular travel of less than half a turn of the rotor 2, or even less than a quarter turn or an eighth of a turn, is chosen to guarantee the efficiency of the magnet-coil coupling, as described below.

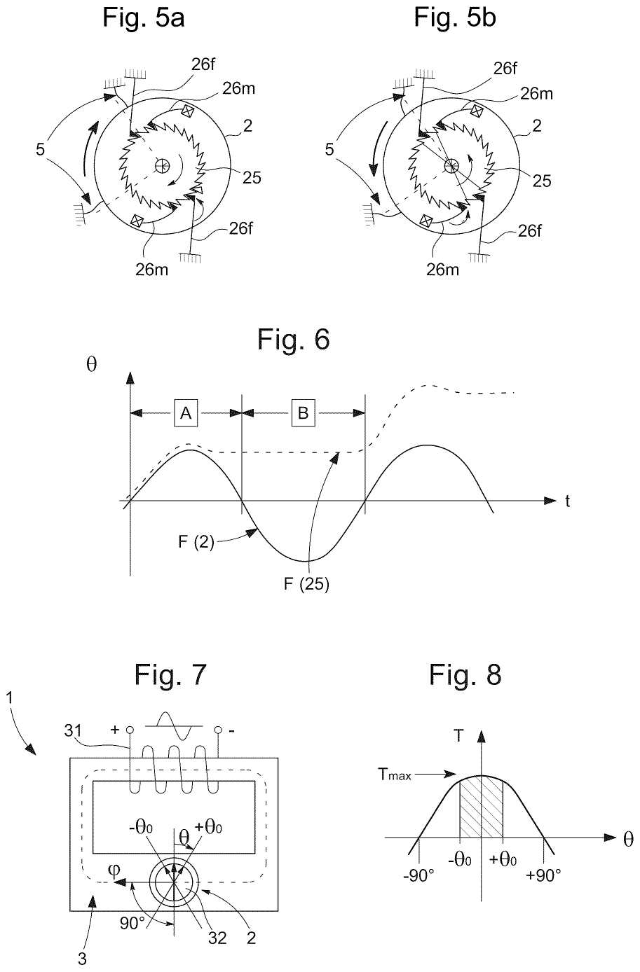

In FIGS. 4 and 5, the motor 1 also comprises a non-return click wheel 25 attached to the meshing pinion 15, so as to retain the meshing pinion 15 in the second direction of rotation of the rotor. Preferably, the click wheel 25 is only located on the upper flexible part 14 of the motor.

Fixed clicks 26f, in this case two, are arranged on the upper flexible part 14 and are attached to the stator 3, and in particular are fitted to the upper plate 8 on the stator 3. The non-return wheel 25 is locked in one direction by the fixed clicks 26f.

Mobile clicks 26m are fitted to the rotor 2 to turn with it.

The meshing pinion 15 and the click wheel 25 are attached to the rotor 2 in a first direction of rotation of the rotor 2, and are fitted so as to pivot freely around the rotation arbor 12 on the rotor 2 in the second direction of rotation of the rotor 2.

The functioning of the motor 1, in particular of the click wheel 25, is illustrated in FIG. 5. When the rotor 2 vibrates, it moves to and fro according to a sinusoidal time function.

During the forward movement A in the first direction, the ratchet wheel 25 and accordingly the meshing pinion 15 turn with the rotor 2 relative to the stator 3, driven by the mobile clicks 26m, while the fixed clicks 26f are reset by the rotation of the ratchet wheel 25. The click wheel 25 has therefore moved one step.

During the return movement B in the second reverse direction, the click wheel 25 is retained by its fixed clicks 26f, while the mobile clicks 26m are reset as a result of the click wheel 25 being retained. During the return, the click wheel 25 therefore remains stationary. In this way, the click wheel 25 makes a one-tooth step at each oscillation period of the rotor 2.

The meshing pinion 15 follows the movement of the click wheel 25. It therefore rotates step by step in the same direction.

In the graph in FIG. 6, the first function F(2) shows the oscillation θ of the rotor 2 as a function of time. The second function F(25) shows the rotation of the click wheel 25 as a function of time. Due to the clicks 26, the click wheel 25 continues to turn in the same direction, despite the return of the rotor 2. The function F(25) therefore increases by one level with each oscillation of the rotor 2 in one direction.

FIG. 7 shows a more general view of the motor 1. The stator 3 is shaped like a substantially square bow, one side of which comprises a bed for the rotor 2, and comprises a coil 31 wound at least partially around another side of the stator 3. The rotor 2 is arranged in the bed and comprises a magnet 32.

When the coil 31 is actuated, the rotor 2 oscillates between two end positions with angles −θ₀ and +θ₀, around the 0° angle, which corresponds to the locked position.

The couple of the motor 1 as a function of the angle of rotation θ is shown in FIG. 6. When the rotor 2 is in the locked position (θ=0), the magnetisation vector of the magnet 2 is directed substantially perpendicular to the main axis of the magnetic flux φ created by the coil 31 in the stator 3. When motor 1 is powered by an alternating voltage, the rotor 2 vibrates between the two end positions −θ₀ and +θ₀.

This angular coverage ideally covers a total angle of less than half a turn, preferably a quarter turn or even an eighth of a turn. The end positions are then close to the maximum magnet-coil couple, so that the electromechanical efficiency is high with such a motor 1.

Preferably, the motor 1 is configured to vibrate at its natural frequency to minimise power consumption. Its natural frequency is determined by the inertia of the rotor 2 and of said resilient return means.

Naturally, the invention is not limited to the embodiments of vibration motors described with reference to the figures, and variants could be envisaged without departing from the scope of the invention.

1. A vibration motor (1), in particular for a horology movement, the motor (1) comprising:
a rotor (2) fitted with a magnet (32);
a stator (3) fitted with at least one coil (31) enabling the rotation of the rotor (2) to be actuated, the rotor (2) being rotationally mobile relative to the stator (3) by oscillation between two end positions, when the rotor is actuated by the coil (31); and
resilient means for returning the rotor between the end positions and an intermediate locked position, when the rotor (2) is no longer actuated by the coil (31), the motor (1) functioning by a rotationally oscillating movement of the rotor (2) to generate each step.

2. The motor according to claim 1, wherein the resilient return means comprise a flexible guide (5) arranged to suspend the rotor (2) from the stator (3).

3. The motor according to claim 2, wherein the flexible guide (5) comprises an upper flexible part (14) connecting the top of the rotor (2) above the stator (3), and a lower flexible part (19) connecting the bottom of the rotor (2) below the stator (3).

4. The motor according to claim 3, wherein the upper flexible part (14) and/or the lower flexible part (19) of the flexible guide (5) comprises at least one pair of uncrossed flexible blades (20), preferably two pairs of uncrossed flexible blades (20, 21) arranged in series.

5. The motor according to claim 2, wherein the upper flexible part (14) and/or the lower flexible part (19) of the flexible guide (5) comprises at least one single flexible blade (22), preferably two single flexible blades (22, 23) arranged on either side of a bow, preferably collinearly.

6. The motor according to claim 4, wherein the flexible guide (5) comprises a static element (27) attached to the stator (3), and a mobile element (28) attached to the rotor (2), the static element (27) and the mobile element (28) being connected by the flexible blades on the flexible guide (5).

7. The motor according to claim 6, wherein the flexible guide (5) comprises an intermediate bow (13) arranged around the rotation arbor (12) on the rotor (2), the two pairs of flexible blades (20, 21) connecting the intermediate bow (13) to the mobile element (28) by a first pair of flexible blades (20), and to the static element (27) by the other pair of flexible blades (21).

8. The motor according to claim 7, wherein the two pairs of flexible blades (20, 21) are symmetrically arranged on either side of the intermediate bow (13).

9. The motor according to claim 5, wherein the flexible guide (5) comprises a static element (27) attached to the stator (3), and a mobile element (28) attached to the rotor (2), the static element (27) and the mobile element (28) being connected by the flexible blades on the flexible guide (5), and the flexible guide (5) comprises a central bow (24) arranged around the rotation arbor on the rotor (2), the single flexible blades connecting the central bow (24) to the mobile element by a first single flexible blade (20), and to the static element (27) by the other single flexible blade.

10. The motor according to claim 1, wherein the motor (1) comprises a meshing pinion (15) for meshing with trains, in particular in the horology movement, the meshing pinion (15) being pivotally fitted above the rotor (2).

11. The motor according to claim 10, wherein the motor comprises a wheel with non-return clicks (25), the wheel (25) being attached to the meshing pinion (15), as well as mobile clicks (26m) fitted on the rotor (2) and fixed clicks (26f) fitted on the stator (2).

12. The motor according to claim 11, wherein the meshing pinion (15) and the click wheel (25) are attached to the rotor (2) in a first direction of rotation of the rotor (2), and are fitted so as to pivot freely around the rotation arbor (12) on the rotor (2) in a second direction of rotation of the rotor (2).

13. The motor according to claim 12, wherein, when the rotor (2) vibrates between two end positions, the click wheel (25) is driven by the mobile clicks (26m) to turn with the rotor (2) relative to the stator (3) in one direction, while the click wheel (25) is retained by the fixed clicks (26f), when the rotor (2) turns in the reverse direction, at each oscillation period of the rotor (2).

14. The motor according to claim 1, wherein the total angle of rotation between the end positions is less than half a turn, preferably less than a quarter turn or even less than an eighth of a turn, so as to oscillate around the maximum magnet-coil couple.

15. The motor according to claim 1, wherein, when in the locked position, the magnetisation vector of the magnet (32) is directed substantially perpendicularly to the main axis of the magnetic flux φ created by the coil (31), so as to obtain a maximum magnet-coil couple.

16. The motor according to claim 1, wherein the motor is configured to vibrate at natural frequency thereof, determined by the inertia of the rotor (2) and of said resilient return means, so as to minimise power consumption.

17. A horology movement, comprising the vibration motor (1) according to claim 1.
